(19) United States
(12) Patent Application Publication
(10) Pub. No.: US 2026/0231963 A1
(43) Pub. Date: Aug. 13, 2026

(54) Extra Thin Tortilla and Method of Making

(71) Applicant: General Mills, Inc., Minneapolis, MN (US)

(72) Inventors: Carina Claudia Cammarota, Pamplona (Navarra) (ES); Jose Daniel Estrada Andino, Roseville, MN (US); Lindsey Golinski, Champlin, MN (US); Yoon Lai Hor, Maple Grove, MN (US); Mikel Lizarraga Cabañas, Pamplona (Navarra) (ES); Anabel Ovejas, Tudela (Navarra) (ES); Asier Ruiz, Pamplona (Navarra) (ES)

(73) Assignee: General Mills, Inc., Minneapolis, MN (US)

(21) Appl. No.: 19/153,771

(22) PCT Filed: Feb. 9, 2023
(86) PCT No.: PCT/US2023/012703

§ 371 Date: Aug. 5, 2025

(51) Int. Cl. A21D 13/42; A21D 2/18

(52) U.S. Cl. CPC A21D 13/42; A21D 2/186

(57) ABSTRACT

Thin, strong tortillas are formed from a dough containing a wheat component, that includes gluten in an amount of about 1.5% to about 10% by dry weight of the dough, and a tapioca starch in an amount of about 2.5% to about 25% by dry weight of the dough. With this formulation, a tortilla can be formed to be less than 1.2 mm in thickness, yet have toughness comparable to thicker, commercially available tortillas.

### BACKGROUND OF THE INVENTION

The present invention pertains to the food art and, more particularly, the making of a thin, strong tortilla that can perform similarly to a thicker tortilla when topped or filled with fillers.

Tortillas are a flatbread popular in many parts of the world, often used for holding toppings or fillings. For many people, tortillas are a regular part of a meal. Some consumers, however, would prefer to reduce the flavor and/or caloric impact of tortillas on their meal. A thinner tortilla could provide these benefits to consumers. Of course, a particular hurdle would be to produce a thinner tortilla product that can perform similarly to a thicker tortilla, without being more prone to breaking or tearing.

### SUMMARY OF THE INVENTION

The present invention relates to thin, strong tortillas. More specifically, the invention is concerned with making soft tortillas with a thickness of less than 1.2 mm and a toughness over thickness value of at least 500 g/mm. Here, the term “thin, strong tortilla” is employed given the similarities between the products produced and traditional tortillas which are common as wraps in making soft tacos, burritos, sandwiches and the like. In addition, the thin, strong tortilla of the invention is designed to be mass produced utilizing certain technology currently associated with traditional tortillas. In accordance with the invention, the thin, strong tortillas include a tortilla base that includes a wheat component and a tapioca starch. In general, a tortilla dough is created and then formed and cooked (e.g., baked) to produce thin, strong tortillas. The thin, strong tortillas can be topped with or filled with a variety of fillers, sweet and/or savory, and perform similarly to thicker tortillas.

In certain embodiments, the tortilla base is formed from a dough including a wheat component in an amount of about 55-75% by dry weight of the dough, including a gluten content of about 1.5-10% by dry weight of the dough, tapioca starch in an amount of about 2.5-25% by dry weight of the dough, fat in an amount of about 3.5-14% by dry weight of the dough, glycerol in an amount of about 4-9% by dry weight of the dough, and approximately 30-40% water.

Optionally, a tortilla, regardless of how thin, can exclude or limit the amount of an artificial preservative (e.g., potassium sorbate, calcium propionate, sodium propionate, propionic acid, sorbic acid) or natural preservative (e.g., cultured wheat, dextrose, or sucrose) and at least partially rely on a pH of at least 9 (e.g., 9 to about 9.8) to limit mold and yeast growth over shelf life.

Additional objects, features and advantages of the invention will become more readily apparent from the following detailed description of the invention when taken in conjunction with the drawings, which illustrate an exemplary embodiment of the invention wherein like reference numerals refer to corresponding parts in the various views.

### BRIEF DESCRIPTION OF THE DRAWINGS

FIG. 1 is a scatter plot graphing the thickness versus toughness of several commercially available tortillas compared to an embodiment of a thin, strong tortilla according to the invention. A trendline for the commercially available tortillas is depicted in a dotted line. As is clear from the graph, the inventive tortillas have a toughness significantly higher than any commercially available tortillas that are less than 1.2 mm in thickness, and a toughness similar to commercially available to tortillas that are 1.3 mm and thicker.

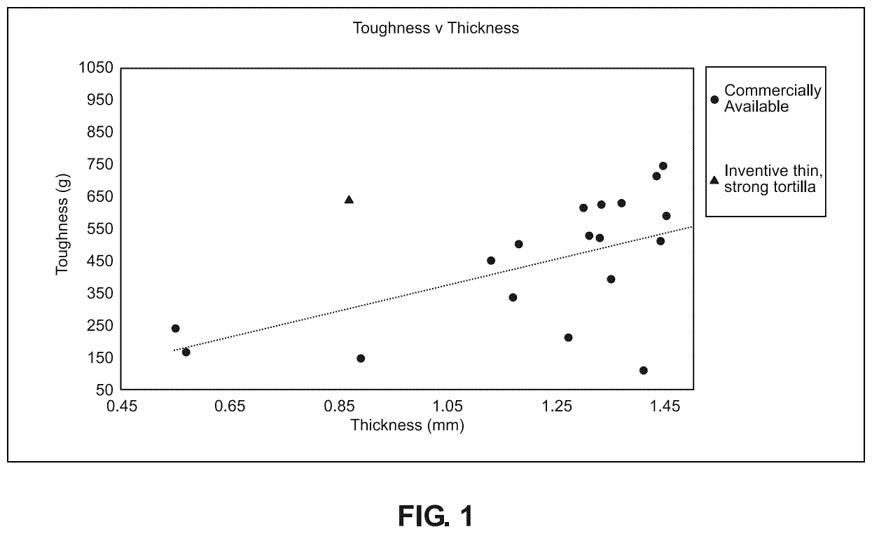

FIG. 2 is a scatter plot graphing the caloric content versus area of several commercially available tortillas compared to an embodiment of a thin, strong tortilla according to the invention. A trendline for the commercially available tortillas is depicted in a dotted line. As is clear from the graph, the inventive tortillas have a caloric content significantly lower than any commercially available tortillas with a similar area. Based on the trendline, the inventive tortillas have a caloric content that would be expected of commercial tortillas that about half the area.

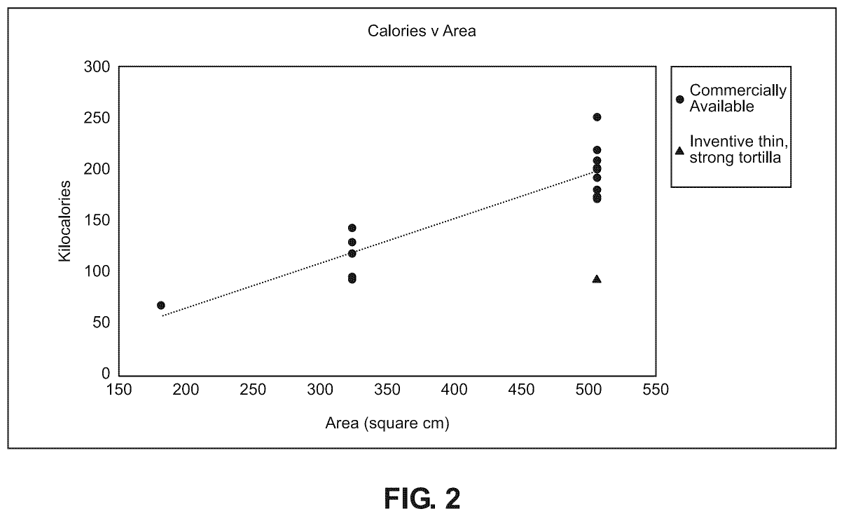

FIG. 3 is a scatter plot graphing the weight versus area of several commercially available tortillas compared to an embodiment of a thin, strong tortilla according to the invention. A trendline for the commercially available tortillas is depicted in a dotted line. As is clear from the graph, the inventive tortillas have a weight significantly lower than any commercially available tortillas with a similar area. Based on the trendline, the inventive tortillas have a weight that would be expected of commercial tortillas that have less than half the area.

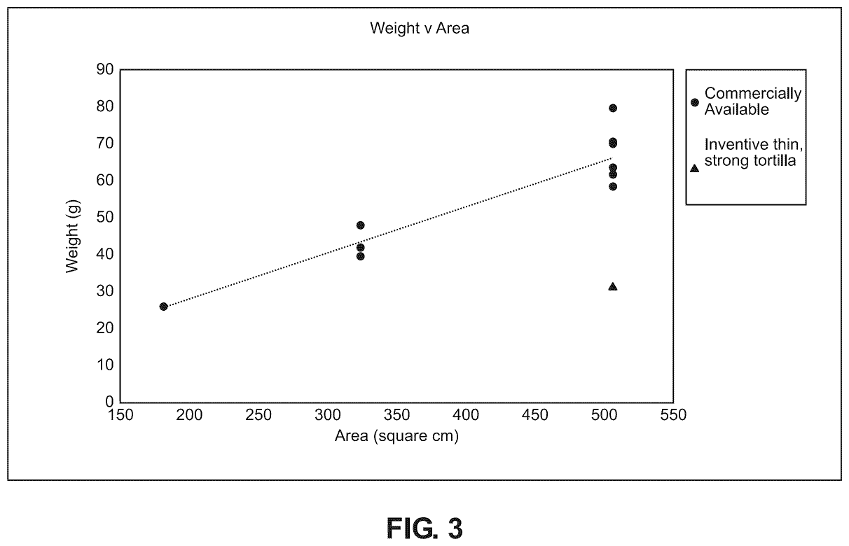

### DETAILED DESCRIPTION OF THE INVENTION

The current invention relates to thin, strong tortillas, particularly soft, flexible tortilla bases that have a thickness of less than 1.2 mm and a toughness over thickness value of at least 500 g/mm. Throughout the specification and claims, percentages are by weight and temperatures in degrees Centigrade unless otherwise indicated. In addition, the term “about” a range of up to 10% variation from the recited value (e.g., about 10% refers to a value ranging 9% to 11%). In addition, a recitation of a value being provided as “less than” a given value, still requires the value to be greater than zero. As used herein, a “soft tortilla” means a fully cooked but non-fried tortilla product which remains soft at room temperature. By comparison, “tortilla dough” means uncooked composition. The resulting tortilla is soft and can be formed or cut into various shapes and sizes, including a flat shape (e.g., oval, circular or even any polygonal shape) or a 3-dimensional shape (e.g., cup, bowl, boat or canoe, flower, pie, tube, envelope, pod, bun, or cone). Regardless of the specific shape, a feature of the present tortillas is a thin, strong construction that can hold toppings or fillings in a manner similar to thicker tortillas. It is to be understood that, while the tortillas of the invention are described as having a thickness of less than 1.2 mm, the thickness across the tortilla can vary. For example, thicknesses can range from about 0.5 mm to less than 1.2 mm across a tortilla. Generally, thickness of a tortilla is measured using a caliper over several points on the tortilla. Typically, thickness of a tortilla is expressed the average of a 5-point measurement, with 4 points measured at the perimeter, close to the edges, and one point measured near the center Provided herein is a packaged, ready-to-eat (RTE) tortilla that has a shelf life of at least 3 months (e.g., 3 months to a year, or 3 months to 10 months), a thickness of about 0.5 to less than 1.2 mm (e.g., about 0.7 to less than 1 mm) in thickness and a toughness over thickness value of at least 500 g/mm (e.g., about 600 to about 1000 g/mm). Such a tortilla performs at least as well as commercially available RTE tortillas that are 1.3 mm or thicker. That is, a tortilla provided herein can hold toppings without tearing or breaking in a similar way to tortillas that are significantly thicker. Such a tortilla can provide a benefit of providing a flexible tortilla that has less impact on the flavor of toppings without sacrificing tortilla strength. In some cases, a thin, strong tortilla provided herein can also contribute fewer calories than a thicker tortilla because it is thinner.

As used herein, shelf life refers to a period of time in which a packaged, RTE tortilla maintains quality and is safe to eat. That is, a packaged, RTE tortilla essentially retains texture, toughness, and flavor attributes over shelf life.

It was discovered that such a tortilla can be made by formulating the tortilla with a particular range of a wheat component (about 55% to about 75%, or about 60% to about 73% by dry weight of the tortilla), including gluten (about 1.5% to about 10%, or about 7% to about 9% by dry weight of the tortilla), and a particular range of tapioca starch (about 2.5% to about 25%, or about 3% to about 22%). The combination of gluten and tapioca starch was found to be particularly important to preserve strength as a tortilla was formed thinner.

A tortilla provided herein includes a wheat component in an amount of about 55% to about 75% (e.g., about 60% to about 73%) by dry weight of the tortilla. As used herein, the term “wheat component” refers to any one or a combination of wheat ingredients, such as wheat flour, wheat bran, vital wheat gluten, or wheat protein isolate. Gluten in included in the tortilla in an amount of about 1.5% to about 10% (e.g., about 7% to about 9%) by dry weight of the tortilla.

Gluten content in a tortilla provided herein can be included as a component of wheat flour and/or as vital wheat gluten or wheat protein isolate. In some embodiments, a tortilla can contain both a wheat flour and additional wheat gluten (e.g., from vital wheat gluten and/or wheat protein isolate) to arrive at a desired gluten content.

A tortilla includes tapioca starch in an amount of about 2.5% to about 25% (e.g., about 3% to about 22%) by dry weight of the tortilla. It was discovered that, while other starches can be included in a tortilla in addition to tapioca starch, removing tapioca starch resulted in a tortilla that was more prone to tearing when formed at thicknesses below 1.2 mm. At this point, it should be noted that tapioca starch can be native or unmodified starch, or modified starch. Modified starches can be prepared by physically, enzymatically or chemically treating the native starch to change the properties of the starch. Typically, if a native or unmodified tapioca starch is used, it can be included in an amount of about 10% to about 25% (e.g., about 10% to about 22%) by dry weight of the tortilla, while if a modified tapioca starch is used, it can be included in an amount of about 2.5% to about 22% (e.g., about 3% to about 20%) by dry weight of the tortilla. In some embodiments, different tapioca starches can be blended.

A tortilla provided herein has a fat content of about 3.5% to about 14% (e.g., about 6% to about 13%) and a glycerol content of about 4% to about 9% (e.g., about 5% to about 8%) by dry weight of the tortilla. In some embodiments, fat content plus glycerol content in a tortilla can be from about 10% to about 22% (e.g., about 12% to about 20%) by dry weight of the tortilla. Fat content in a tortilla can be from any appropriate source, such as a vegetable oil or shortening (e.g., soybean oil, canola or rapeseed oil, corn oil, palm oil, or the like, or any combination thereof), an animal fat, or any combination thereof. Fat content and glycerol content in a tortilla can contribute to shelf-life by contributing to a low water activity and/or contribute to texture stability (e.g., pliability) of a RTE tortilla over shelf life. Water activity (Aw) of a tortilla provided herein is typically less than 0.90 (e.g., about 0.86 to about 0.895) to limit microbial growth.

In some embodiments, a tortilla can include a bicarbonate salt, such as sodium bicarbonate, in an amount of up to 2% (e.g., about 0.4% to about 1.5%, or about 0.6% to about 1.2%) by dry weight of the tortilla. Typically, commercially available RTE tortillas include an artificial preservative and/or a natural preservative to limit yeast and mold growth. Such preservatives are effective at a pH below 7, or about 5.5 to about 6.5. However, it was discovered that including a pH adjuster, such as a bicarbonate salt, in an amount sufficient to adjust the pH of a tortilla to 9 or above (e.g., 9 to about 9.8) can limit yeast and mold growth over shelf life with little or no other artificial preservative (e.g., potassium sorbate, calcium propionate, sodium propionate, propionic acid, sorbic acid) or natural preservative (e.g., cultured wheat, dextrose, or sucrose). Surprisingly, this effect can be seen even if packaging in which tortillas are enclosed is breached. This discovery can be applied to any packaged, RTE tortilla, including those other than the thin, strong tortillas described herein.

A tortilla provided herein can include additional optional components in a total amount of up to 8% by dray weight of the tortilla. Such ingredients can include, for example, emulsifiers (e.g., in amounts of up to about 2.5%, or about 1% to about 2% by dry weight), enzymes (e.g., in amounts of up to about 0.1%, or about 0.01% to about 0.08% by dry weight), flavorants, sugars, and/or seasonings (e.g., in amounts of up to about 2.5%, or about 1% to about 2% by dry weight), preservatives (e.g., in amounts of up to about 2%, or 0% to about 1.2% by dry weight), salt (e.g., in amounts of up to about 1.5%, or 0.2% to about 1.2% by dry weight), leavening byproducts (e.g., in amounts of up to about 3%, or 0% to about 2.5% by dry weight), and the like. It is to be understood that a leavening byproduct can include reacted and/or unreacted components of a leavening acid/base pair. Thus, a leavening byproduct can include a bicarbonate salt that can serve as a pH adjuster as described above. However, a thin, strong tortilla need not be leavened.

As mentioned above, a thin, strong tortilla provided herein has a thickness of less than 1.2 mm (e.g., 0.5 mm to less than 1.2 mm, or about 0.7 to less than 1 mm) and have a toughness over thickness value of at least 500 g/mm (e.g., about 600 to about 1000 g/mm). The toughness over thickness value of a tortilla is determined by dividing the toughness of the tortilla by the thickness of the tortilla.

As used herein, toughness is measured using a TA. XT Plus texture analyzer (Stable Microsystems, Surrey, United Kingdom) fitted with the spherical probe (P/1S) of a Tortilla/Pastry Burst Rig (HDP/TPB) (Stable Microsystems, Surrey, United Kingdom). A tortilla is placed between the upper and lower holding plates of the Tortilla/Pastry Burst Rig and each of the 4 screws are pushed down to pierce the tortilla and hold it in place for measurement. The holding plates are secured to the platform of the TA. XT Plus. The spherical probe is positioned about 2-4 cm above the tortilla. Using Exponent Software (Stable Microsystems, Surrey, United Kingdom), the tortilla is subjected to testing using the program “comparison of biaxial extensibility of two formulations of wheat flour tortillas” with the following settings:
Mode: Measure Force in Compression
Option: Return to Start
Pre-test Speed: 1.0 mm/s
Test Speed: 1.0 mm/s
Post-test Speed: 10 mm/s
Distance: 40 mm
Trigger Type: Auto-5 g
Tare Mode: Auto
Data Acquisition Rate: 200 pps
Toughness of a tortilla is measured as an average of at least 3 tortillas of the peak force or force at break in grams. In some embodiments, toughness is at least 500 g (e.g., about 600 g to about 1000 g, or about 600 g to about 800 g).

A thin, strong tortilla provided herein can be any desirable shape, including flat or 3-dimensional. For example, a thin, strong tortilla can be a traditional flat tortilla in any appropriate shape, such as round or square. A thin, strong tortilla can have a benefit of being able to hold toppings without tearing even when the tortilla is relatively large (e.g., a width of about 15 cm to about 26 cm, or an area of about 150 cm² to about 680 cm² ). In another example, a thin, strong tortilla can be a 3-dimensional shape, such as a cup, bowl, boat or canoe, flower, pie, tube, envelope, pod, bun, and cone.

A thin, strong tortilla can weigh less on a per area basis than commercially available tortillas. For example, a thin, strong tortilla can have a weight of less than 0.1 g/cm² (e.g., about 0.04 g/cm² to about 0.08 g/cm²), while most commercially available tortillas have a weight ranging from 0.12 g/cm² to 0.16 g/cm², with an average of about 0.13 g/cm². Similarly, a thin, strong tortilla can have a relatively low caloric content per area basis. For example, a thin, strong tortilla can have a caloric content of less than 0.25 Kcal/cm² (e.g., about 0.10 Kcal/cm² to about 0.22 Kcal/cm²), while most commercially available tortillas have caloric content ranging from 0.29 Kcal/cm² to 0.5 Kcal/cm², with an average of about 0.38 Kcal/cm².

Moisture content in a thin, strong tortilla can typically be from about 25% to about 40% (e.g., about 25% to about 35%) by weight.

A thin, strong tortilla can be made using any appropriate equipment. Generally, a method of making a thin, strong tortilla includes combining ingredients to make a dough. A dough includes the components described above, generally. For example, a dough can include a wheat component in an amount of from about 55% to about 75% by dry weight, including a gluten content of about 1.5% to about 10% by dry weight, tapioca starch in an amount of about 2.5% to about 25% by dry weight, a fat content of about 3.5% to about 14% by dry weight, and a glycerol content of about 4% to about 9% by dry weight. A dough typically has a moisture content of about 30% to about 50% (e.g., about 30% to about 40%) by weight.

A dough can then be formed to make an uncooked tortilla having a thickness of about 0.5 mm to less than 1.2 mm (e.g., less than 1 mm) using any appropriate method, and then cooked (e.g., baked) to produce a thin, strong tortilla described herein. Flat uncooked tortillas can be made in a number of different ways. For example, an uncooked tortilla can be made by sheeting dough and cutting the dough into a desired size and shape. In another example, an uncooked tortilla can be made by pressing a portion of dough into a flat shape with a desired size and shape.

In some embodiments, a dough can be formed into a 3-dimensional shape by pressing the dough into at least one mold comprising the 3-dimensional shape to form an uncooked tortilla, and heating the uncooked tortilla in the mold until fully cooked and formed into the shape of the mold to make a thin, strong tortilla that holds the 3-dimensional shape and remains pliable over shelf life. In some embodiments, a dough can be formed into a 3-dimensional shape by pressing the dough into at least one mold comprising the 3-dimensional shape to form an uncooked tortilla, and heating the uncooked tortilla in the mold until partially cooked and formed into the shape of the mold, then removing the shaped, partially cooked tortilla from the mold and further heating the shaped, partially cooked tortilla until fully cooked to make a thin, strong tortilla that holds the 3-dimensional shape and remains pliable over shelf life.

A method of preserving a packaged, RTE tortilla is also provided. The method preserving a packaged, RTE tortilla generally includes the steps of combining ingredients to make a tortilla dough that does not contain an artificial preservative (e.g., potassium sorbate, calcium propionate, sodium propionate, propionic acid, sorbic acid) or natural preservative (e.g., cultured wheat, dextrose, or sucrose), adjusting the dough to a pH of at least 9 (e.g., 9 to about 9.8); forming the dough to make an uncooked tortilla, and cooking the uncooked tortilla to form the RTE tortilla, where the RTE tortilla has a water activity of about 0.86 to less than 0.97 (e.g., about 0.86 to less than 0.96, or from about 0.86 to less than 0.92). A tortilla made according to a method of preserving a packaged, RTE tortilla provided herein can have a shelf life of at least 3 months (e.g., 3 months to a year, or 3 months to 10 months) without including an artificial preservative (e.g., potassium sorbate, calcium propionate, sodium propionate, propionic acid, sorbic acid) or natural preservative (e.g., cultured wheat, dextrose, or sucrose). This method can be used for any appropriate tortilla, such as flour tortillas, gluten free tortillas, and the like. For example, a flour tortilla can contain about 55% to about 65% flour, about 5% to about 15% fat, about 4% to about 8% glycerol, a pH adjuster in an amount sufficient to achieve a dough pH of at least 9, a water activity of about 0.86 to less than 0.97, and no artificial preservative or natural preservative.

Still, even with the details presented above, it is to be understood that the examples and specified percentages set forth herein are for purposes of illustrating particular embodiments of the invention such that various modifications and additions can be made to the exemplary embodiments discussed without departing from the scope of the present invention.

1. A packaged, ready-to-eat (RTE) tortilla, comprising:
a. a wheat component in an amount of about 55% to about 75% by dry weight of the tortilla, including a gluten content of about 1.5% to about 10% by dry weight of the tortilla;
b. tapioca starch in an amount of about 2.5% to about 25% by dry weight of the tortilla;
c. a fat content of about 3.5% to about 14% by dry weight of the tortilla;
d. a glycerol content of about 4% to about 9% by dry weight of the tortilla;
e. a thickness of about 0.5 mm to less than 1.2 mm;
f. a toughness over thickness value of at least 500 g/mm;
g. a water activity of less than 0.90; and
h. a shelf life of at least 3 months.

2. The packaged, RTE tortilla of claim 1, wherein the tortilla is a flat tortilla.

3. The packaged, RTE tortilla of claim 1, wherein the tortilla is a preformed 3-dimensional shape.

4. The packaged, RTE tortilla of claim 1, wherein the thickness is from about 0.7 mm to less than 1 mm.

5. The packaged, RTE tortilla of claim 1, wherein the toughness over thickness value is about 600 g/mm to about 1000 g/mm.

6. The packaged, RTE tortilla of claim 1, wherein the tortilla has a weight of less than 0.1 g/cm².

7. The packaged, RTE tortilla of claim 1, consisting of:
a. a wheat component in an amount of about 60% to about 73% by dry weight of the tortilla, including a gluten content of about 7% to about 9% by dry weight of the tortilla;
b. tapioca starch in an amount of about 3% to about 22% by dry weight of the tortilla;
c. a fat content of about 6% to about 13% by dry weight of the tortilla;
d. a glycerol content of about 5% to about 8% by dry weight of the tortilla, wherein the fat content plus the glycerol content is from about 12% to about 20% by dry weight of the tortilla;
e. a bicarbonate salt in an amount of about 0.4% to about 1.5% by dry weight of the tortilla; and
f. other ingredients in an amount of up to 8% by dry weight of the tortilla.

8. The packaged, RTE tortilla of claim 1, wherein the shelf life is at least 6 months.

9. The packaged RTE tortilla of claim 1, wherein the tortilla has a pH of at least 9.

10. The packaged RTE tortilla of claim 9, wherein the tortilla contains no artificial preservative or natural preservative.

11. A method of making a ready-to-eat (RTE) tortilla, comprising:
a. combining ingredients to make a dough, the dough including:
1) a wheat component in an amount of about 55% to about 75% by dry weight of the dough, including a gluten content of about 1.5% to about 10% by dry weight of the dough;
2) tapioca starch in an amount of about 2.5% to about 25% by dry weight of the dough;
3) a fat content of about 3.5% to about 14% by dry weight of the dough;
4) a glycerol content of about 4% to about 9% by dry weight of the dough; and
5) a moisture content of about 30% to about 50% by weight of the dough;
b. forming the dough into an uncooked tortilla having a thickness of about 0.5 mm to less than 1.2 mm;
c. cooking the uncooked tortilla to a moisture content of from about 20% to about 30% to form the RTE tortilla, where the RTE tortilla has water activity of less than 0.9, a thickness of about 0.5 mm to less than 1.2 mm, and a toughness over thickness value of at least 500 g/mm.

12. The method of claim 11, wherein the dough has a pH of at least 9.

13. The method of claim 11 wherein the dough consists of
1) a wheat component in an amount of about 60% to about 73% by dry weight of the dough, including a gluten content of about 7% to about 9% by dry weight of the dough;
2) tapioca starch in an amount of about 3% to about 22% by dry weight of the dough;
3) a fat content of about 6% to about 13% by dry weight of the dough;
4) a glycerol content of about 35% to about 8% by dry weight of the dough;
6) a moisture content of about 35% to about 40% by weight of the dough;
7) a bicarbonate salt in an amount of up to 2% by dry weight of the dough; and
8) other ingredients in an amount of up to 8% by dry weight of the dough.

14. The method of claim 12, wherein the wherein the tortilla contains no artificial preservative or natural preservative.

15. The method of claim 11, wherein forming comprises sheeting and cutting the dough to form the uncooked tortilla.

16. The method of claim 11, wherein forming comprises pressing the dough into a flat uncooked tortilla.

17. The method of claim 11, wherein forming comprises pressing the dough into at least one mold comprising a shape to form an uncooked tortilla having a 3-dimensional shape, and cooking comprises heating the uncooked tortilla in the mold until fully cooked and formed into the shape of the mold.

18. (canceled)

19. The method of claim 11, comprising packaging the tortilla.

20. A method of preserving a packaged, ready-to-eat (RTE) tortilla, comprising:
a. combining ingredients to make a tortilla dough that contains no artificial preservative or natural preservative;
b. adjusting the dough to a pH of at least 9;
c. forming the dough into an uncooked tortilla;
c. cooking the uncooked tortilla to form the RTE tortilla, where the RTE tortilla has water activity of about 0.86 to less than 0.97 and a shelf life of at least 3 months.

21. A packaged, ready-to-eat (RTE) tortilla made according to the method of claim 20.
